(19) United States
(12) Patent Application Publication
(10) Pub. No.: US 2026/0150854 A1
(43) Pub. Date: Jun. 4, 2026

(54) METHOD AND SYSTEM FOR TREATING MILK

(71) Applicant: SHAHEEN INNOVATIONS HOLDING LIMITED, Abu Dhabi (AE)

(72) Inventor: Mohammed Alshaiba Saleh Ghannam Almazrouei, Abu Dhabi (AE)

(21) Appl. No.: 19/255,050

(22) Filed: Jun. 30, 2025

Related U.S. Application Data
(60) Provisional application No. 63/727,131, filed on Dec. 2, 2024.

(51) Int. Cl. A23B 11/16; A23C 9/14

(52) U.S. Cl. CPC A23B 11/164; A23B 11/162; A23C 9/14

(57) ABSTRACT

A method of treating milk for reducing a microbial population in a liquid milk product. The method comprising passing the liquid milk product through a first channel, wherein the first channel comprises at least one first ultraviolet-C (UV-C) emitter. Irradiating the liquid milk product in the first channel with UV-C light emitted from the UV-C emitter to reduce a microbial population in the liquid milk product. Outputting the liquid milk product through the first channel and into a container, wherein the container comprises at least one ultrasonic transducer. Emitting ultrasonic waves from the ultrasonic transducer into the liquid milk product in the container to cause cavitation in the liquid milk product to lyse microbial cells in the liquid milk product. Outputting the liquid milk product through the container and into a second channel, wherein the second channel comprises at least one second UV-C emitter. Irradiating the liquid milk product in the second channel with UV-C light emitted from the second UV-C emitter to expose microbial cells in the liquid milk product to the UV-C light to promote long term stability of the liquid milk product.

### CROSS-REFERENCE TO RELATED APPLICATION

The present application claims the benefit of priority to U.S. Provisional Patent Application No. 63/727,131, filed on 2 Dec. 2024, which is incorporated herein by reference in its entirety.

### FIELD

The present invention relates to a method and system for treating milk. The present invention more particularly relates to a method and system for reducing a microbial population in a liquid milk product.

### BACKGROUND

Pasteurisation is a process which is applied to food products such as dairy products, to destroy harmful pathogens and prolong the shelf life of the products. Conventional pasteurisation methods involve heating the food product to a particular temperature for a prescribed time. These methods are known as thermal pasteurisation.

In conventional thermal pasteurisation, the food product is heated to a temperature between 60-110° C. (140-230° F.). However, the food product may alternatively be heated to a higher temperature for a shorter period of time to provide an even longer shelf life.

There is evidence to suggest that there are disadvantages to conventional thermal pasteurisation of milk. There may be detrimental effects on nutritional value, such as a reduction in vitamin concentrations. Additionally, there may be changes in smell and taste attributes. For example, camel's milk, due to its high mineral content and delicate proteins, requires gentle pasteurization methods to retain its nutritional properties.

Similarly, lab-grown milk and plant-based alternatives have unique compositions that demand careful handling to avoid nutrient loss or structural damage.

Some evidence also indicates that thermal pasteurisation alone may not effectively eliminate all microorganisms and other contaminants which can be found in milk.

In recent years, several non-thermal pasteurisation technologies are emerging, but these technologies are largely experimental in nature and heat is the pasteurisation method of choice for many food products commercially.

There is a need for a method and system for treating milk that alleviates at least some of the problems outlined herein.

### BRIEF DESCRIPTION OF THE INVENTION

The present invention provides a method for treating milk as claimed in claim 1, an apparatus for treating milk as claimed in claim 12 and an apparatus for treating milk as claimed in claim 20. The present invention also provides preferred embodiments as claimed in the dependent claims.

In some examples of this disclosure, the apparatus for treating milk provides enhanced reduction of microbial populations in milk and increases the shelf life of the milk.

In some examples of this disclosure, the apparatus for treating milk provides reduced microbial populations in milk while retaining greater nutritional value as well as smell and taste attributes in comparison to conventional thermal pasteurisation.

In some examples of this disclosure, the apparatus for treating milk reduces the concentration of non-organic contaminants which may be present in milk.

In some examples of this disclosure, the apparatus for treating milk provides an environmental benefit over conventional thermal pasteurisation in that the apparatus for treating milk may require less energy to reduce microbial populations in milk because the apparatus does not incorporate a heating element.

### Representative Features

Representative features are set out in the following clauses, which stand alone or may be combined, in any combination, with one or more features disclosed in the text and/or drawings of the specification.
1. A method of treating milk for reducing a microbial population in a liquid milk product, the method comprising: passing the liquid milk product through a first channel, wherein the first channel comprises a first turbulence promoter and at least one first ultraviolet-C (UV-C) emitter; irradiating the liquid milk product in the first channel with UV-C light emitted from the at least one first UV-C emitter to reduce a microbial population in the liquid milk product, wherein the first turbulence promoter creates turbulence in the liquid milk product to expose the liquid milk product in the first channel to the UV-C light; outputting the liquid milk product through the first channel and into a container, wherein the container comprises at least one ultrasonic transducer; emitting ultrasonic waves from the at least one ultrasonic transducer into the liquid milk product in the container to cause cavitation in the liquid milk product to lyse microbial cells in the liquid milk product; outputting the liquid milk product through the container and into a second channel, wherein the second channel comprises a second turbulence promoter and at least one second UV-C emitter; irradiating the liquid milk product in the second channel with UV-C light emitted from the at least one second UV-C emitter to expose microbial cells in the liquid milk product to the UV-C light to promote long term stability of the liquid milk product, wherein the second turbulence promoter creates turbulence in the liquid milk product to expose the liquid milk product in the second channel to the UV-C light; and passing the liquid milk product out of the second channel and into a vessel for containing the liquid milk product.
2. The method of clause 1 further comprising using a transducer driver to drive the at least one ultrasonic transducer at a frequency of 20 kHz to 40 KHz.
3. The method of clause 1 or clause 2 further comprising using a flow control system to regulate a flow rate of the liquid milk product through at least one of the first channel, the container and the second channel to a flow rate of 1 litre per minute to 10 litres per minute.
4. The method of any one of the preceding clauses further comprising using an ultrasound control system to monitor and control the operation of at least one ultrasonic transducer.
5. The method of any one of the preceding clauses further comprising using a UV-C control system to control the at least one of the at least one first UV-C emitter and the at least one second UV-C emitter.
6. The method of any one of the preceding clauses further comprising using at least one temperature sensor to measure the temperature of the liquid milk product in at least one of the first channel, the container and the second channel.
7. The method of any one of the preceding clauses further comprising: passing the liquid milk product through a filtration system; and filtering the liquid milk product using the filtration system to remove particulate matter and debris.
8. The method of any one of the preceding clauses further comprising using a cooling device to cool the liquid milk product to a temperature of 4° C. to 6° C.
9. The method of any one of the preceding clauses wherein the liquid milk product is at least one liquid milk product selected from a group comprising dairy milk, camel milk, lab-grown milk, and plant-based milk.
10. The method of any one of the preceding clauses wherein at least one of the at least one first UV-C emitter and the at least one second UV-C emitter outputs UV-C light at a wavelength of 180 nm to 280 nm.
11. The method of any one of the preceding clauses wherein at least one of the at least one first UV-C emitter and the at least one second UV-C emitter outputs UV-C light at an energy density of 5 mJ/cm² to 15 mJ/cm².
12. The method of any one of the preceding clauses wherein at least one of the first channel and the second channel comprises at least one respective flexible conduit.
13. The method of clause 12 wherein at least part of the at least one flexible conduit is translucent.
14. The method of clause 12 wherein at least one of the at least one first UV-C emitter and the at least one second UV-C emitter are embedded in a wall of the at least one flexible conduit.
15. An apparatus for treating milk for reducing a microbial population in a liquid milk product, the apparatus comprising: a first channel comprising: a first channel inlet; a first channel outlet; at least one first ultraviolet-C (UV-C) emitter configured to emit UV-C light to irradiate the liquid milk product to reduce a microbial population in the liquid milk product; and a first turbulence promoter configured to create turbulence in the liquid milk product to expose the liquid milk product in the first channel to the UV-C light; a container comprising: a container inlet which is in fluid communication with the first channel outlet; a container outlet; at least one ultrasonic transducer configured to emit ultrasonic waves into the liquid milk product in the container to cause cavitation in the liquid milk product to lyse microbial cells in the liquid milk product; a second channel comprising: a second channel inlet which is in fluid communication with the container outlet; a second channel outlet; at least one second ultraviolet-C (UV-C) emitter configured to emit UV-C light to irradiate the liquid milk product to reduce a microbial population in the liquid milk product; and a second turbulence promoter configured to create turbulence in the liquid milk product to expose the liquid milk product in the second channel to the UV-C light.
16. The apparatus of clause 15 further comprising a transducer driver which is configured to drive the at least one ultrasonic transducer at a frequency of 20 kHz to 40 KHz.
17. The apparatus of clause 15 or clause 16 further comprising a flow control system which is configured to regulate a flow rate of the liquid milk product through at least one of the first channel, the container and the second channel to a flow rate of 1 litre per minute to 10 litres per minute.
18. The apparatus of any one of clauses 15 to 17 further comprising an ultrasound control system which is configured to monitor and control the operation of at least one ultrasonic transducer.
19. The apparatus of any one of clauses 15 to 18 further comprising a UV-C control system which is configured to control the at least one of the at least one first UV-C emitter and the at least one second UV-C emitter.
20. The apparatus of any one of clauses 15 to 19 further comprising at least one temperature sensor which is configured to measure the temperature of the liquid milk product in at least one of the first channel, the container and the second channel.
21. The apparatus of any one of clauses 15 to 20 further comprising a filtration system which is configured to filter the liquid milk product using the filtration system to remove particulate matter and debris.
22. The apparatus of any one of clauses 15 to 21 further comprising a cooling device which is configured to cool the liquid milk product to a temperature of 4° C. to 6° C.
23. The apparatus of any one of clauses 15 to 22 wherein the liquid milk product is at least one liquid milk product selected from a group comprising dairy milk, camel milk, lab-grown milk, and plant-based milk.
24. The apparatus of any one of clauses 15 to 23 wherein at least one of the at least one first UV-C emitter and the at least one second UV-C emitter is configured to output UV-C light at a wavelength of 180 nm to 280 nm.
25. The apparatus of any one of clauses 15 to 24 wherein at least one of the at least one first UV-C emitter and the at least one second UV-C emitter is configured to output UV-C light at an energy density of 5 mJ/cm² to 15 mJ/cm².
26. The apparatus of any one of clauses 15 to 25 wherein at least one of the first channel and the second channel comprises at least one respective flexible conduit.
27. The apparatus of clause 26 wherein at least part of the at least one flexible conduit is translucent.
28. The apparatus of clause 26 wherein at least one of the at least one first UV-C emitter and the at least one second UV-C emitter are embedded in a wall of the at least one flexible conduit.
29. An apparatus for treating milk for reducing a microbial population in a liquid milk product, the apparatus comprising: a first channel comprising: a first channel inlet; a first channel outlet; at least one first ultraviolet-C (UV-C) emitter configured to emit UV-C light to irradiate the liquid milk product to reduce a microbial population in the liquid milk product; a container comprising: a container inlet which is in fluid communication with the first channel outlet; a container outlet; at least one ultrasonic transducer configured to emit ultrasonic waves into the liquid milk product in the container to cause cavitation in the liquid milk product to lyse microbial cells in the liquid milk product; a second channel comprising: a second channel inlet which is in fluid communication with the container outlet; a second channel outlet; at least one second ultraviolet-C (UV-C) emitter configured to emit UV-C light to irradiate the liquid milk product to reduce a microbial population in the liquid milk product.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a diagrammatic view of an apparatus for treating milk of this disclosure.

FIG. 2 is a diagrammatic view of a first channel of this disclosure.

FIG. 3 is a diagrammatic view of a first channel of this disclosure.

FIG. 4 is a diagrammatic view of a container of this disclosure.

FIG. 5 is a diagrammatic view of an apparatus for treating milk of this disclosure.

FIG. 6 is a block diagram showing components of an apparatus for treating milk of this disclosure.

### DETAILED DESCRIPTION OF THE DISCLOSURE

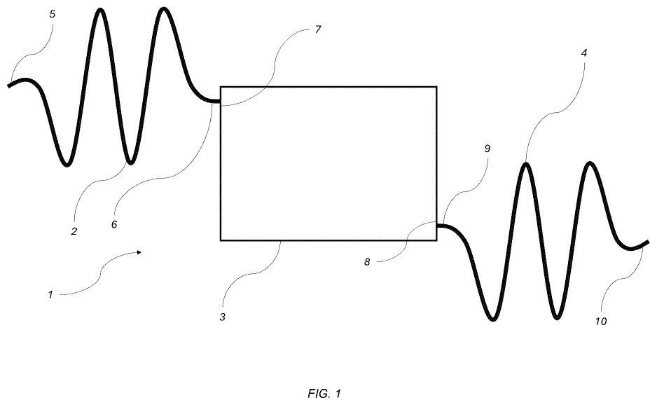

Referring initially to FIG. 1 of the accompanying drawings, an apparatus for treating milk 1 of examples of this disclosure comprises a first channel 2, a container 3 and a second channel 4. In this example, the first channel 2 is in fluid communication with the container 3. In this example, the container 3 is in fluid communication with the second channel 4.

The first channel 2 comprises a first channel inlet 5 which is configured to receive milk and a first channel outlet 6 which is configured to output the milk. The container 3 comprises a container inlet 7 which is configured to receive the milk and a container outlet 8 which is configured to output the milk. The second channel 4 comprises a second channel inlet 9 which is configured to receive the milk and a second channel outlet 10 which is configured to output the milk. In the example of the disclosure shown in FIG. 1, the first channel outlet 6 is in fluid communication with the container inlet 7 and the container outlet 8 is in fluid communication with the with the second channel inlet 9.

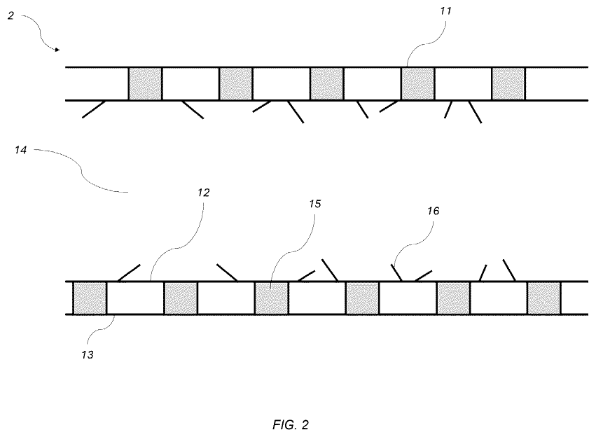

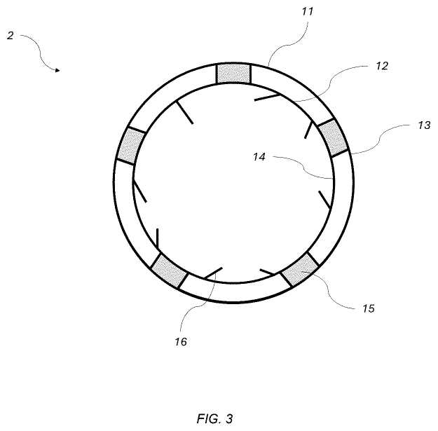

Referring now to FIGS. 2 and 3 of the accompanying drawings, the first channel 2 and the second channel 4 are substantially similar, for ease of simplicity only the first channel 2 will be described here. The first channel 2 of this example of the disclosure is formed of an elongate and generally tubular body 11, the tubular body 11 comprising an inner surface 12 and an outer surface 13. In this example, the first channel 2 comprises an inner region 14 which is enclosed by the inner surface 12. In other examples of the disclosure, the first channel 2 may comprise an elongate channel having a plurality of sides but not enclosed. In other examples, the first channel 2 may be formed of a fluid pathway formed in a solid body.

In this example, the tubular body 11 is of a flexible material. In this example, the tubular body 11 is a conduit, hose or a pipe.

In the examples of the disclosure shown in FIGS. 1 to 5 of the accompanying drawings, the first channel 2 is formed of a single tubular body 11, however in other examples the first channel 2 is formed of a plurality of tubular bodies, non-tubular elongate channels or fluid pathways.

The first channel 2 further comprises at least one first ultraviolet-C (UV-C) emitter 15 which is configured to emit UV-C light. In the examples of this disclosure shown in FIGS. 2 and 3, the first channel 2 comprises a plurality of first UV-C emitters 15. In this example of the disclosure, the first UV-C emitter 15 is embedded in the tubular body 11 of the first channel 2. In this example, the first UV-C emitter 15 emits UV-C light into the inner region 14 of the first channel 2 to irradiate the milk and expose microbial cells in the milk to UV-C light to reduce the microbial population and promote long term stability of the milk. In some examples, the first UV-C emitter 15 emits UV-C light directly into the inner region 14. In other examples first UV-C emitter 15 may emit UV-C light through the inner surface 12 and into the inner region 14. In other examples, the first UV-C emitter 15 may be coupled to the inner surface 12. In other examples, the tubular body 11 may be of a transparent material. In such examples, the first UV-C emitter 15 may alternatively be coupled to the outer surface 13 or not coupled to the tubular body 11.

In the example of the disclosure shown in FIG. 2, the first channel 2 comprises a plurality of first UV-C emitters 15 longitudinally spaced along the tubular body 11. In the example of the disclosure shown in FIG. 3, the first channel 2 comprises a plurality of first UV-C emitters 15 circumferentially spaced around the tubular body 11. The first UV-C emitter 15 is configured to emit UV-C light at a wavelength of 254 nm. In other examples, the first UV-C emitter 15 is configured to emit UV-C light at a wavelength of 180 nm to 280 nm. In this example, the first UV-C emitter 15 is configured to output UV-C light at an energy density of 5 mJ/cm² to 15 mJ/cm².

The UV-C emitter 15 reduces the microbial population in the milk without heating the milk. This ensures retention of vitamins, proteins, and bioactive compounds, particularly in delicate milk types such as camel milk and lab-grown milk.

The first channel 2 of this example of the disclosure further comprises at least one first turbulence promoter 16 which is configured to create turbulence in the milk. In this example, the first turbulence promoter 16 is coupled to the inner surface 12 of the tubular body 11. In some examples, the first turbulence promoter 16 is configured to obstruct fluid flow passing through the inner region 14. In such examples, the first turbulence promoter 16 may comprise a substantially planar body, a substantially three-dimensional volume or a sections of the inner surface 12 which project into the inner region 14. In other examples, the first turbulence promoter 16 may comprise an indentation on the inner surface 12 which increases the cross-sectional area of the inner region 14. In some examples, the first turbulence promoter 16 comprises a combination of being configured to obstruct fluid flow passing through the inner region 14 and an indentation on the inner surface 12. In some examples, the turbulence promoter 16 is omitted.

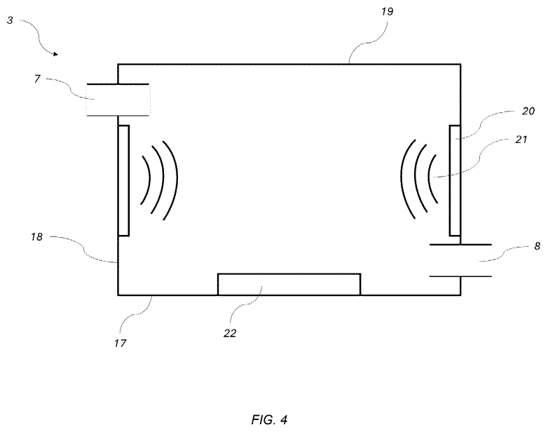

Turning now to FIG. 4 of the accompanying drawings, the container 3 of this example of the disclosure further comprises a base 17 and a side wall 18. In some examples such as the example shown in FIG. 4, the container 3 further comprises a top surface 19. In some examples, the container may be of stainless-steel. The container 3 further comprises at least one ultrasonic transducer 20 configured to emit ultrasonic waves 21 into the milk in the container. The ultrasonic waves 21 creates cavitation bubbles in the milk. The collapse of these cavitation bubbles generates localized high temperatures (50-70° C.) and mechanical forces, effectively disrupting microbial cells and deactivating enzymes, without adding significant heat to the milk. In the example of the disclosure shown in FIG. 4, the container 3 comprises a plurality of ultrasonic transducers 20 which are coupled to the side wall 18. In other examples, the at least one ultrasonic transducer 20 may be coupled to the base 17. In some examples, the at least one ultrasonic transducer 20 may be coupled to a transducer holder which is coupled to the container 3.

The use of the first UV-C light emitter 15 reduces the microbial load in the milk before the milk is exposed to the ultrasonic waves 21. This improves the efficiency of ultrasound sonication step.

In the example of the disclosure shown in FIG. 4, the container 3 further comprises a container cooling device 22 which is configured to maintain the temperature of milk in the container 3 to be within a prescribed range. In this example, the container cooling device 22 is coupled to the base 17. In other examples, the container cooling device 22 may be coupled to the side wall 18 or the top surface 19. In this example, the container cooling device 22 is configured to cool the milk to a temperature of 4° C. to 6° C., ensuring the retention of vitamins, proteins, and bioactive compounds. In other examples, the container cooling device 22 is omitted.

The first channel 2 and the second channel 4 are substantially similar and therefore the second channel 4 has the same features as the first channel 2 described above and as shown in FIGS. 2 and 3.

The second channel 4 irradiates the milk using UV-C light again to ensure complete microbial inactivation and long-term stability of milk.

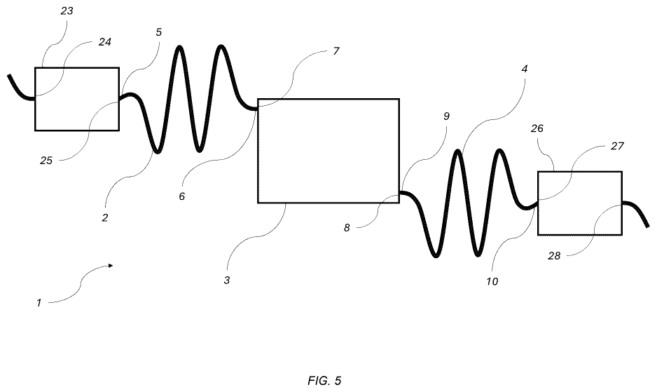

Referring now to FIG. 5 of the accompanying drawings, the apparatus for treating milk 1 of this example further comprises a filter 23, the filter 23 comprising a filter inlet 24 which is configured to receive the milk and a filter outlet 25. In this example, the filter outlet 25 is in fluid communication with the first channel inlet 5. The filter 23 is configured to filter the milk and remove particulate matter and debris which may be in the milk. In other examples, the filter 23 is omitted.

In this example, the apparatus for treating milk 1 further comprises an outlet cooling device 24. In this example, the outlet cooling device 26 comprises an outlet cooling device inlet 27 and an outlet cooling device outlet 28. In this example, the outlet cooling device inlet 27 of the outlet cooling device 26 is in fluid communication with the second channel outlet 10 of the second channel 4. The outlet cooling device 26 is configured to maintain the temperature of milk output by the second channel 4 to be within a prescribed range. In this example, the outlet cooling device 26 is configured to cool the milk to a temperature of 4° C. to 6° C. In other examples, the outlet cooling device 26 is omitted.

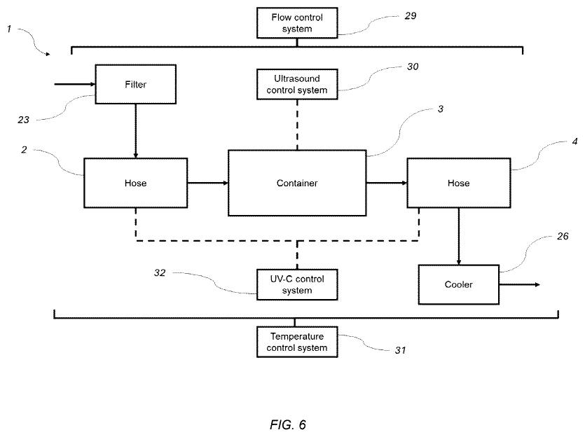

Referring now to FIG. 6 of the accompanying drawings, the apparatus for treating milk 1 of this example further comprises a flow control system 29 which is configured to regulate a flow rate of fluid through at least one of the first channel 2, the container 3 and the second channel 4. The flow control system 29 comprises at least one flow sensor. The flow control system 29 further comprises at least a pump or valve which is configured to control the fluid flow rate. Regulating the flow rate of the milk allows the flow control system 29 to optimise the exposure of the milk to the ultrasonic waves 21 and the UV-C light emitted by the first UV-C emitter 15 and the second UV-C emitter 15. In this example, the flow control system 29 is configured to regulate the milk to a flow rate of 1 litre per minute to 10 litres per minute. The flow control system 29 functions may be implemented in a computing system.

In the example of the disclosure shown in FIG. 6, the apparatus for treating milk 1 further comprises an ultrasound control system 30 which is configured to monitor and control the at least one ultrasonic transducer 20. In this example, the ultrasound control system 30 is configured to control a transducer driver which is configured to drive the at least one ultrasonic transducer 20 at a frequency of 20 kHz to 40 kHz. The ultrasound control system 30 functions may be implemented in a computing system which may be the same computing system as the flow control system 29 or may be a separate computing system.

In the example of the disclosure shown in FIG. 6, the apparatus for treating milk 1 further comprises a temperature control system 31 which comprises at least one temperature sensor configured to measure the temperature of the milk in at least one of the first channel 2, the container 3 and the second channel 4. In this example, the temperature control system 31 functions may be implemented in a computing system which may be the same computing system as the flow control system 29 and the ultrasound control system 30 or may be a separate computing system.

In the example of the disclosure shown in FIG. 6, the apparatus for treating milk 1 further comprises a UV-C control system 32 which comprises at least one light sensor which is configured to monitor light intensity, included in at least one of the first UV-C emitter 15 and the second UV-C emitter 15. The UV-C control system 32 is configured to control the at least one of the first UV-C emitter 15 and the second UV-C emitter 15. In this example, the UV-C control system 32 functions may be implemented in a computing system which may be the same computing system as the flow control system 29, the ultrasound control system 30 and the temperature control system 31, or may be a separate computing system.

In some examples, at least one of the flow control system 29, the ultrasound control system 30 and the temperature control system 31 and the UV-C control system 32 may be configured to perform a data logging function.

A method of treating milk to reduce microbial population in the milk using the apparatus for treating milk 1 will now be described. In examples of the disclosure comprising a filter 23, the milk first enters the filter 23 through the filter inlet 24. The milk then passes through the filter 23 and particulate matter and debris is removed from the milk.

The milk then leaves the filter 23 through the filter outlet 25 and enters the first channel 2 through the first channel inlet 5. In examples where the apparatus for treating milk 1 does not comprise a filter 23, the milk enters the apparatus for treating milk 1 directly through the first channel inlet 5.

The milk enters the first channel inlet 5 and passes through the first channel 2 where the first UV-C emitter 15 emits UV-C light which irradiates the milk to reduce a microbial population in the milk. In this example, the first turbulence promoter 16 creates turbulence in the milk to expose the milk in the first channel 2 to the UV-C light.

The milk is output through the first channel outlet 6 and enters the container 3 through the container inlet 7. The at least one ultrasonic transducer 20 emits ultrasonic waves 21 into the milk in the container 3 to cause cavitation in the milk to lyse microbial cells in the milk. In this example, the ultrasound control system 30 control the transducer driver to drive the at least one ultrasonic transducer 20 at a frequency of 20 kHz to 40 KHz.

In this example, the container cooling device 22 cools the milk to a temperature of 4° C. to 6° C.

The milk is output through the container outlet 8 and enters the second channel 4 through the second channel inlet 9. The milk passes through the second channel 4 where at least one second UV-C emitter 15 emits UV-C light which irradiates the milk to reduce a microbial population in the milk. In this example, at least one second turbulence promoter 16 creates turbulence in the milk to expose the milk in the second channel 4 to the UV-C light.

The hybrid method of reducing the microbial population in the milk may achieve a minimum of a 5-log reduction of microbial population in the milk.

In this example, the milk is output through the second channel outlet 10 and enters the outlet cooling device 26 through the outlet cooling device inlet 27. In this example, the outlet cooling device 26 cools the milk to a temperature of 4° C. to 6° C.

The apparatus for treating milk of examples of this disclosure provide enhanced reduction of microbial populations in milk and increases the shelf life of the milk. The milk is not subjected to high temperatures and therefore the nutritional value as well as smell and taste attributes of the milk is not negatively impacted.

Additionally, apparatus for treating milk of examples of this disclosure reduce the concentration of non-organic contaminants which may be present in milk.

The apparatus for treating milk of examples of this disclosure may also require less energy to reduce microbial populations in milk when compared to conventional thermal pasteurisation because the apparatus does not incorporate a heating element.

The apparatus for treating milk of examples of this disclosure may allow for adaptation in small-scale dairy farms and large industrial processing plants due to the modular design of the apparatus.

In other examples the milk may be a liquid milk product such as cow milk, buffalo milk, camel milk or goat. In other examples the milk may be lab-grown milk or a milk alternative such as a plant-based milk. In other examples, instead of milk the apparatus is for treating a liquid food product such as fruit juice.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

Examples or embodiments of the subject matter and the functional operations described herein can be implemented in digital electronic circuitry, or in computer software, firmware, or hardware, including the structures disclosed in this specification and their structural equivalents, or in combinations of one or more of them.

Some examples or embodiments are implemented using one or more modules of computer program instructions encoded on a computer-readable medium for execution by, or to control the operation of, a data processing apparatus. The computer-readable medium can be a manufactured product, such as hard drive in a computer system or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The terms “computing device” and “data processing apparatus” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices.

1. A method of treating milk for reducing a microbial population in a liquid milk product, the method comprising:
passing the liquid milk product through a first channel, wherein the first channel comprises a first turbulence promoter and at least one first ultraviolet-C (UV-C) emitter;
irradiating the liquid milk product in the first channel with UV-C light emitted from the at least one first UV-C emitter to reduce a microbial population in the liquid milk product, wherein the first turbulence promoter creates turbulence in the liquid milk product to expose the liquid milk product in the first channel to the UV-C light;
outputting the liquid milk product through the first channel and into a container, wherein the container comprises at least one ultrasonic transducer;
emitting ultrasonic waves from the at least one ultrasonic transducer into the liquid milk product in the container to cause cavitation in the liquid milk product to lyse microbial cells in the liquid milk product;
outputting the liquid milk product through the container and into a second channel, wherein the second channel comprises a second turbulence promoter and at least one second UV-C emitter;
irradiating the liquid milk product in the second channel with UV-C light emitted from the at least one second UV-C emitter to expose microbial cells in the liquid milk product to the UV-C light to promote long term stability of the liquid milk product, wherein the second turbulence promoter creates turbulence in the liquid milk product to expose the liquid milk product in the second channel to the UV-C light; and
passing the liquid milk product out of the second channel and into a vessel for containing the liquid milk product.

2. The method of claim 1 further comprising using a transducer driver to drive the at least one ultrasonic transducer at a frequency of 20 kHz to 40 KHz.

3. The method of claim 1 further comprising using a flow control system to regulate a flow rate of the liquid milk product through at least one of the first channel, the container and the second channel to a flow rate of 1 litre per minute to 10 litres per minute.

4. The method of claim 1 further comprising:
using an ultrasound control system to monitor and control the operation of at least one ultrasonic transducer;
using a UV-C control system to control the at least one of the at least one first UV-C emitter and the at least one second UV-C emitter; and
using at least one temperature sensor to measure the temperature of the liquid milk product in at least one of the first channel, the container and the second channel.

5. The method of claim 1 further comprising:
passing the liquid milk product through a filtration system; and
filtering the liquid milk product using the filtration system to remove particulate matter and debris.

6. The method of claim 1 further comprising using a cooling device to cool the liquid milk product to a temperature of 4° C. to 6° C.

7. The method of claim 1 wherein the liquid milk product is at least one liquid milk product selected from a group comprising dairy milk, camel milk, lab-grown milk, and plant-based milk.

8. The method of claim 1 wherein at least one of the at least one first UV-C emitter and the at least one second UV-C emitter outputs UV-C light at a wavelength of 180 nm to 280 nm.

9. The method of claim 1 wherein at least one of the at least one first UV-C emitter and the at least one second UV-C emitter outputs UV-C light at an energy density of 5 mJ/cm² to 15 mJ/cm².

10. The method of claim 1 wherein at least one of the first channel and the second channel comprises at least one respective flexible conduit.

11. The method of claim 10 wherein at least one of the at least one first UV-C emitter and the at least one second UV-C emitter are embedded in a wall of the at least one flexible conduit.

12. An apparatus for treating milk for reducing a microbial population in a liquid milk product, the apparatus comprising:
a first channel comprising:
a first channel inlet;
a first channel outlet;
at least one first ultraviolet-C (UV-C) emitter configured to emit UV-C light to irradiate the liquid milk product to reduce a microbial population in the liquid milk product; and
a first turbulence promoter configured to create turbulence in the liquid milk product to expose the liquid milk product in the first channel to the UV-C light;
a container comprising:
a container inlet which is in fluid communication with the first channel outlet;
a container outlet;
at least one ultrasonic transducer configured to emit ultrasonic waves into the liquid milk product in the container to cause cavitation in the liquid milk product to lyse microbial cells in the liquid milk product;
a second channel comprising:
a second channel inlet which is in fluid communication with the container outlet;
a second channel outlet;
at least one second ultraviolet-C (UV-C) emitter configured to emit UV-C light to irradiate the liquid milk product to reduce a microbial population in the liquid milk product; and
a second turbulence promoter configured to create turbulence in the liquid milk product to expose the liquid milk product in the second channel to the UV-C light.

13. The apparatus of claim 12 further comprising a transducer driver which is configured to drive the at least one ultrasonic transducer at a frequency of 20 kHz to 40 KHz.

14. The apparatus of claim 12 further comprising:
a flow control system which is configured to regulate a flow rate of the liquid milk product through at least one of the first channel, the container and the second channel to a flow rate of 1 litre per minute to 10 litres per minute;
an ultrasound control system which is configured to monitor and control the operation of at least one ultrasonic transducer; and
a UV-C control system which is configured to control the at least one of the at least one first UV-C emitter and the at least one second UV-C emitter.

15. The apparatus of claim 12 further comprising:
at least one temperature sensor which is configured to measure the temperature of the liquid milk product in at least one of the first channel, the container and the second channel;
a filtration system which is configured to filter the liquid milk product using the filtration system to remove particulate matter and debris; and
a cooling device which is configured to cool the liquid milk product to a temperature of 4° C. to 6° C.

16. The apparatus of claim 12 wherein the liquid milk product is at least one liquid milk product selected from a group comprising dairy milk, camel milk, lab-grown milk, and plant-based milk.

17. The apparatus of claim 12 wherein at least one of the at least one first UV-C emitter and the at least one second UV-C emitter is configured to output UV-C light at a wavelength of 180 nm to 280 nm.

18. The apparatus of claim 12 wherein at least one of the at least one first UV-C emitter and the at least one second UV-C emitter is configured to output UV-C light at an energy density of 5 mJ/cm² to 15 mJ/cm².

19. The apparatus of claim 12 wherein at least one of the first channel and the second channel comprises at least one respective flexible conduit and wherein at least one of the at least one first UV-C emitter and the at least one second UV-C emitter are embedded in a wall of the at least one flexible conduit.

20. An apparatus for treating milk for reducing a microbial population in a liquid milk product, the apparatus comprising:
a first channel comprising:
a first channel inlet;
a first channel outlet;
at least one first ultraviolet-C (UV-C) emitter configured to emit UV-C light to irradiate the liquid milk product to reduce a microbial population in the liquid milk product;
a container comprising:
a container inlet which is in fluid communication with the first channel outlet;
a container outlet;
at least one ultrasonic transducer configured to emit ultrasonic waves into the liquid milk product in the container to cause cavitation in the liquid milk product to lyse microbial cells in the liquid milk product;
a second channel comprising:
a second channel inlet which is in fluid communication with the container outlet;
a second channel outlet;
at least one second ultraviolet-C (UV-C) emitter configured to emit UV-C light to irradiate the liquid milk product to reduce a microbial population in the liquid milk product.
